(19) United States
(12) Patent Application Publication
(10) Pub. No.: US 2012/0311899 A1
(43) Pub. Date: Dec. 13, 2012

(54) HANGING PLACARD WITH POUCH AND RELATED METHOD OF MANUFACTURING

(75) Inventors: James L. Mathewson, Syracuse, NY (US); George Bastedo, Clyde, NY (US)

(73) Assignee: LAURAVILLE PACKAGING, LLP, Geneva, NY (US)

(21) Appl. No.: 13/492,222

(22) Filed: Jun. 8, 2012

Related U.S. Application Data
(60) Provisional application No. 61/495,725, filed on Jun. 10, 2011.

(51) Int. Cl. G09F 7/18; B32B 38/04; B29C 65/08; G09F 3/04

(52) U.S. Cl. 40/310; 40/617; 156/253; 156/73.1

(57) ABSTRACT

A hanging placard assembly with a pouch and a related method of manufacturing are provided. The hanging placard has a base layer and a pouch formed thereon by securing a film to selected locations on the base. A top edge of the pouch may be sealed to form an enclosure or left open. A hole or at least one slit is formed in the base between the pouch and the top edge of the base to define a hanging portion. The hanging portion is dimensioned to be mounted on a bottle or other object. The item retained between the pouch can be a product sample, an instruction booklet, promotional material, or any other item. A method is provided for manufacturing the hanging placard, including the steps of unwinding rolls of base material and film, placing items at intervals on the base material, and selectively sealing the film thereover.

This application claims priority on U.S. Provisional Application No. 61/495,725 filed on Jun. 10, 2011.

### BACKGROUND OF THE INVENTION

1. Field of the Invention

The present disclosure relates generally to the field of hanging placards and a method for making the same. The hanging placard is provided with an enclosed pouch or open pocket for holding promotional material.

2. Description of the Related Art

Hanging placards have long been used to attach promotional material to a product in order to influence consumers at the point of purchase. Manufacturers hope to entice customers to purchase a particular product in exchange for the promise of a discount on the product being sold or on a related product. However, the vast majority of these tags lack the ability to provide product samples, three dimensional items, or instruction booklets.

In other cases, promotional material is formed on a removable label affixed to the exterior of a beverage container with adhesive. For instance, a label may be removed from a bottle and used as a coupon for a free or discounted beverage. There are several drawbacks to this arrangement. First, the label cannot accommodate the attachment of a three dimensional product sample or other high value item. Secondly, there is a limited amount of copy space on most labels. Third, many labels with expanded copy features are not suitable for application to curved surfaces such as bottles. Further, the attachment of labels to a bottle at the time the bottle is filled limits the ability of retailers to change the promotion at a later time and in some cases results in unsold product displaying expired promotions. Easily removable devices have been created to overcome the problems associated with bottle and label based promotions.

U.S. Pat. No. 3,797,658 discloses a package attachment for containers. A hanging placard is disclosed having top and bottom flat portions. A round opening is formed in the top flat portion by punching a plug from the top flat portion. The opening is formed with a number of slits radiating outward from the opening and is dimensioned to be smaller than a bottle cap and bottle neck. The bottle cap is forced through the opening and the slits allow the opening to expand and then contract around the bottle neck. The bottom flat portion is articulated to the top flat portion along a fold line to extend normal to and downward from the top flat portion. A plurality of golf tees are laminated onto the bottom flat portion. The hangtag disclosed in U.S. Pat. No. 3,797,658 is manufactured from a sheet of cardboard or chipboard with a plurality of spaced apart hangtag locations. The sheet of cardboard is cut with a cutting tool or puncher at the hangtag locations to have multiple series of intersecting lines. Golf tees are placed on the sheet at positions below the intersecting lines. A sheet of plastic film is placed over the cardboard sheet, the golf tees, and the intersecting lines and heat sealed to become a laminated, coated surface of the sheet permanently sealed thereon. The sheet is then placed into a die cutting machine and the individual tags are punched from the sheet.

U.S. Pat. No. 3,149,431 is directed toward a self-aligning neck card label. U.S. Pat. No. 3,149,431 discloses top, bottom, and intermediate portions. The top portion lies in a horizontal plane and has an opening through which a bottle neck passes. The intermediate portion is folded along first and second fold lines so that it is normal to the top portion. The bottom portion extends downward from the second fold line in a direction normal to the horizontal plane of the top portion. The bottom portion has promotional material printed directly thereon. The promotional material is not protected and is prone to damage due to abrasive contact with other materials during transportation and storage.

U.S. Pat. No. 6,799,390 discloses a greetings device having a loop for securement to a bottle. The greeting device is substantially rectangular and has an inverted U-shaped slit for attachment to a bottle. A message, such as “Happy Birthday,” is printed directly on the hang tag. Hence, damage may still occur to the message during transportation. U.S. Pat. No. 6,799,390 also discloses an envelope for the greeting device. The envelope comprises upper and lower pockets. A lower end of the hang tag opposite the U-shaped slit is placed in the lower pocket and a section of the hanging placard inside the U-shaped slit is inserted into the upper pocket, thereby protecting the message portion of the hanging placard from contact with foreign objects. A portion of the hanging placard on the exterior of the U-shaped slit is placed around the bottle neck. However, the message is hidden from view, thereby eliminating any promotional benefits from the hang tag.

Further, various other hanging carriers have been known in the art, including promotional materials inserted into clear bags with hole punches therethrough for attachment to another item. These hanging carriers are labor intensive as they require hand assembly. Moreover, the clear bags are open at a top end, exposing the promotional item to damage during storage and transportation. Printed hangtags with items glued thereon are also well known in the prior art. However, items are manually glued to the hangtags, thereby increasing labor and production costs. The items are not covered by an overlying layer and are also prone to damage.

It is an object of the present invention to provide a hanging placard with an enclosed pouch or open pocket for delivery of promotional messages.

It is a further object of the present invention to provide a hanging placard with promotional material visible to a potential consumer.

It is a still further object of the present invention to provide a hanging placard with promotional material that can be easily removed from the hanging placard by adding an inline perforation to a top film or by slitting or overlapping the top film.

It is a still further object of the present invention to provide a method for manufacturing a hanging placard with promotional material automatically inserted.

It is another object of the invention to provide a method for manufacturing a hanging placard with promotional material that can be supplied in a continuous format suitable for either manual or automatic application.

### SUMMARY OF THE INVENTION

The present disclosure is directed to a hanging placard assembly having a base layer formed from a paper, paper board, film or foil material, which may be printed or unprinted. The hanging placard assembly base may be formed from a single layer of material or multiple layers laminated together.

The base may be of any shape or size. However, in the preferred embodiment, the base is defined by parallel left and right edges with top and bottom edges extending therebetween. The top edge in the preferred embodiment is curved so that a distance between the top and bottom edges at a position equidistant from the left and right edges is greater than a length of the left and right edges.

A pocket or pouch is formed on the base near the bottom edge by securing a film to selected locations on the base. The film preferably is transparent. The pocket or pouch is preferably spaced inward from the left and right edges. At a minimum, the left, right, and bottom edges of the pocket or pouch preferably are parallel to the left, right, and bottom edges of the base, respectively. At least the left, right and bottom edges of the pocket or pouch are laminated, welded, or adhesively affixed to the base. A top edge of the pocket or pouch is preferably sealed to form an enclosure. However, in an alternate embodiment, the top edge of the pocket or pouch is not affixed to create an opening. An item is retained between the film and the base.

A hole or at least one slit is formed in the base between the pocket or pouch and the top edge of the base. For example, a U-shaped slit has left and right sections spaced inward from and substantially parallel to the left and right edges of the base. A curved portion extends between the left and right sections and is spaced inward from the top edge of the base. Opposite ends of the U-shaped slit preferably are at or slightly above the pocket or pouch so that the pocket or pouch prevents, inhibits, or limits tearing at the ends of the U-shaped slit. A flap is formed within the U-shaped slit. The flap has left and right vertical portions and a curved top portion following the outline of the U-shaped slit. A bottom portion of the flap is integral with the base. The flap can be folded around the bottom portion. A hanging portion is formed between the U-shaped slit and the left, right, and top edges of the base. Of course, other types or shapes of holes or slits can be provided between the pocket or pouch and the top edge of the base.

The hanging portion is dimensioned to be mounted over the neck of a bottle or a doorknob or other object for which a pressure sensitive label would not be suitable. An inner dimension of the hanging portion, defined by the hole or U-shaped slit, should fit over a bottle cap and hang around the neck of the bottle. The base of the hanging placard preferably lays flat against a body of the bottle with the pocket or pouch facing outward and away from the body of the bottle. The flap extends outward from the hanging placard and may be substantially planar with the base. However, the flap may be folded inward around the bottom portion so that it is sandwiched between the base of the placard and the body of the bottle.

The item retained between the pocket or pouch and the base preferably is a product sample, an instruction or disclosure booklet, a coupon or promotional material. However, the item can also be a prize, a message, or a greeting. Still further, product samples may include a tea bag, an “on-the-go” drink mix, or a food product. The item preferably has at least one printed surface visible through the transparent film.

A method is provided for manufacturing the hanging placard. The method includes an unwinding step in which both a continuous web of base material and a continuous web of top film are unwound from rolls. Each material may be printed with a graphic or copy, or may remain blank. The top film may cover a portion of or the entire base material. The tension of the continuous web of base material and continuous web of top film is adjusted to remove any folds, wrinkles, or creases that may occur during unwinding. The method further includes placing items such as coupons or promotional material on the continuous web of base material at predetermined intervals. The web and the film then are passed through a nip to sandwich the item between the base and the film. The film then is secured to the base material at selected locations, for example by thermal laminating, heat sealing or sonic welding, by activating an adhesive layer previously applied to the film or the base material, or by securing the film to the base material by self-wound overlaminate, thereby retaining the item between the base material and the film. The areas of attachment of the film to the base material preferably extend continuously along an edge of the base material and at spaced apart strips extending perpendicular to the edge to form pockets or pouches.

The method preferably proceeds with one or more die cutting steps that include cutting or punching holes or U-shaped slits into the elongate base material at predetermined intervals symmetrically corresponding to the positions of the pockets or pouches and the promotional materials therein. A steel rule die or rotary die may be used to make the U-shaped slits. The holes or U-shaped slits are disposed between and spaced from the pockets or pouches and a top edge of the base material.

The method further includes cutting perforation lines into the base material at areas between the pockets or pouches such that the base material can be supplied in a continuous format suitable for manual or automatic application.

The method may further include die cutting the edges of the individual hanging placards or the punch holes to have decorative edges thereon or individually sheeting on press. The decorative edge may be rounded or any type of pattern.

The method may also include winding the plurality of hanging placards onto a role for easy transportation and storage.

The method may also include adding an inline perforation, splitting, or overlapping the top film to allow for the easy opening of the pouch.

### BRIEF DESCRIPTION OF THE DRAWINGS

FIG. 1 is a perspective view of a hanging placard mounted on a bottle.

FIG. 2 is a plan view of the hanging placard having an open pocket.

FIG. 3 is a cross-sectional view taken along Line 3-3 in FIG. 2.

FIG. 4 is a plan view of a plurality of hanging placards prior to cutting.

FIG. 5 is a plan view of the hanging placard having a pouch with promotional materials enclosed.

FIG. 6 is a cross-sectional view taken along Line 6-6 of FIG. 5

FIG. 7 is a flow diagram illustrating a method of manufacturing hanging placards.

### DETAILED DESCRIPTION OF THE PREFERRED EMBODIMENTS

All examples and conditional language recited herein are intended for teaching purposes to aid the reader in understanding the principles of the disclosure and the concepts contributed by the inventor to furthering the art, and are to be construed as being without limitation to such specifically recited examples and conditions.

Moreover, all statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

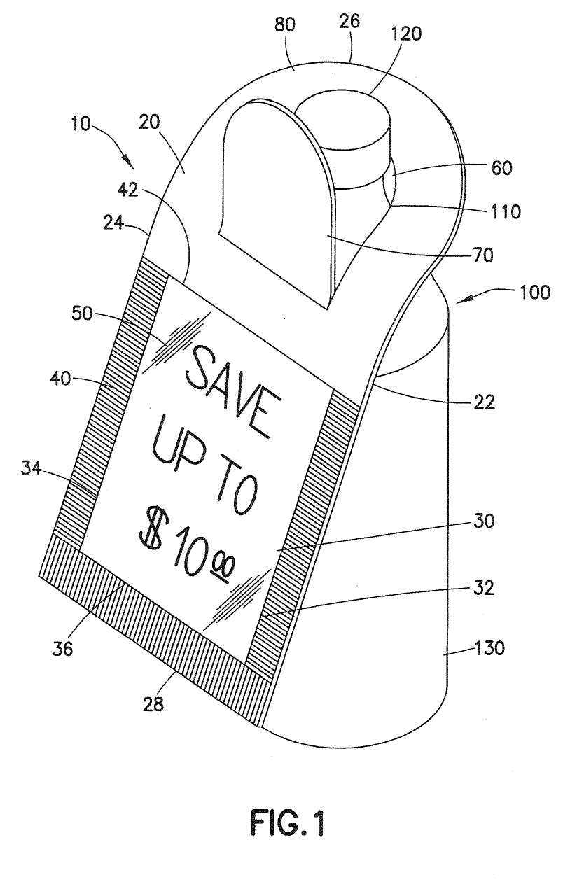

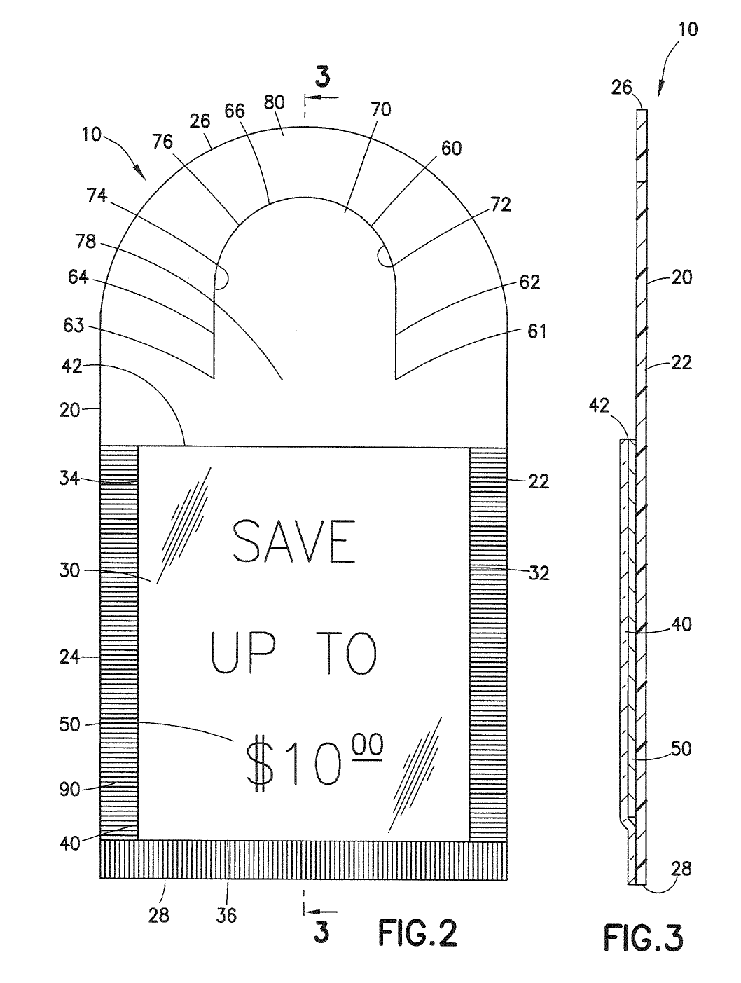

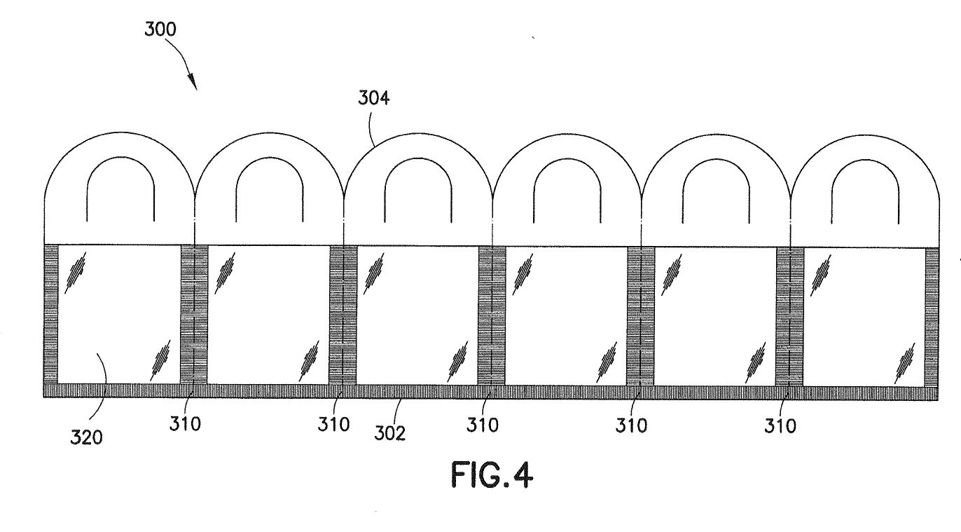

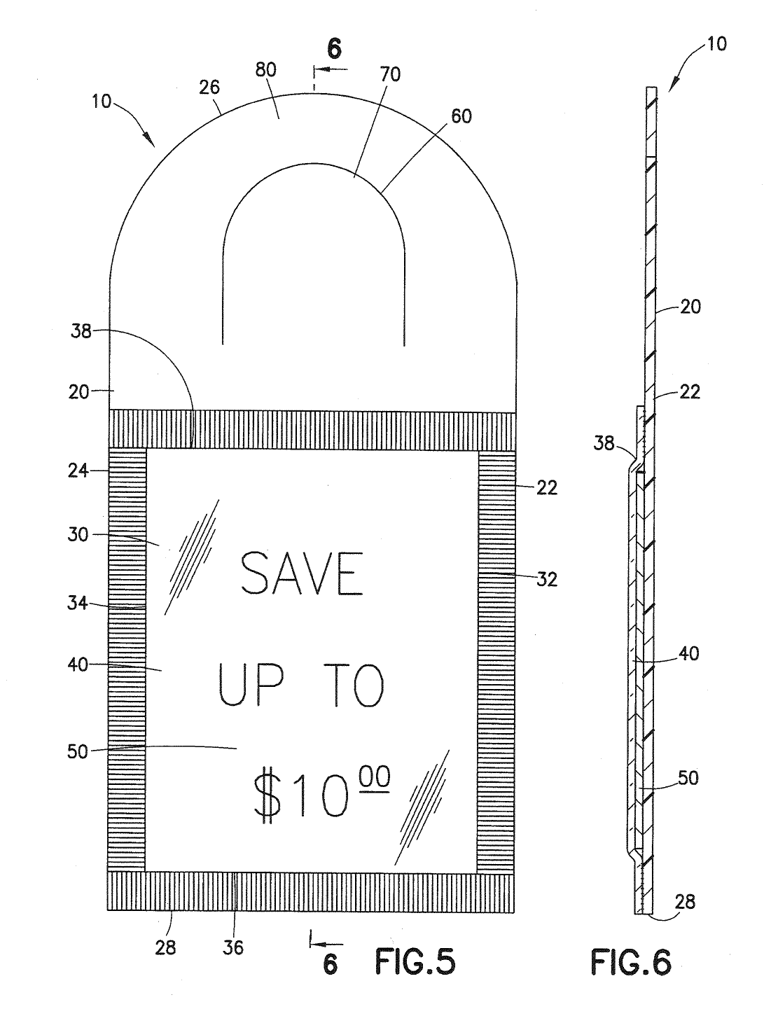

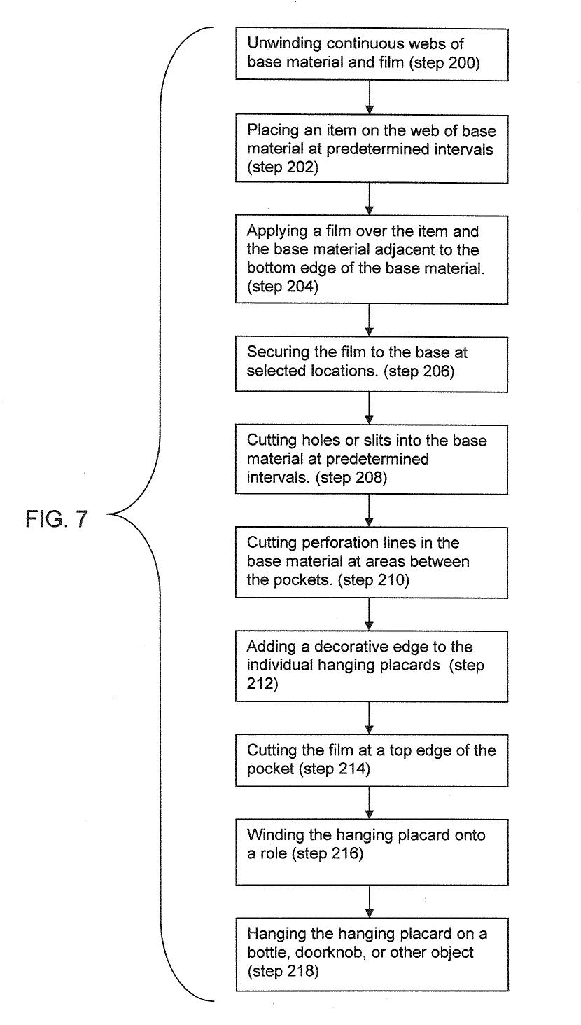

With reference to the drawings, embodiments of the present disclosure will be described. As shown in FIG. 1 a hanging placard assembly 10 having a base layer 20 is provided. The base layer may be paper, paper board, film, foil, or any other type of material or combination of materials. The base 20 may be formed from a single layer of material or multiple layers laminated or stacked together.

The base 20 may be of any shape or size. However, in the preferred embodiment, the base 20 is defined by parallel left and right edges 22, 24 with top and bottom edges 26, 28 extending therebetween. The top edge 26 in the preferred embodiment is curved so that a distance between the top and bottom edges 26, 28 at a position equidistant from the left and right edges 22, 24 is greater than a length of the left and right edges 22, 24. The base 20 may be printed to have a graphic, copy, or any type of indicia.

A pocket or pouch 30 is formed on the base 20 near the bottom edge 28 by securing a film 40 to selected locations of the base 20. The film 40 is preferably transparent. The pocket or pouch 30 is preferably spaced inward from the left and right edges 22, 24 of the base 20. Preferably, at least left, right, and bottom edges 32, 34, 36 of the pocket or pouch 30 preferably are parallel to the left, right, and bottom edges 22, 24, 28 of the base, respectively. At least the left, right and bottom edges 32, 34, 36 of the pocket or pouch 30 are welded or adhesively affixed to the base 20. A top edge 38 of the pocket or pouch 30 is parallel to the bottom edge 36 and is defined by an opening 42. At least one item 50 is inserted into the opening 42 in the pocket or pouch 30 and is retained between the base 20 and laminated film 40.

A hole or U-shaped slit 60 is formed in the base 20 between the pocket or pouch 30 and the top edge 26 of the base 20. The hole or U-shaped slit 60 has left and right vertical sections 62, 64 spaced from and substantially parallel to the left and right edges 22, 24 of the base 20. A curved portion 66 extends between the left and right sections 22, 24 and is spaced from the top edge 26 of the base 20. Opposite ends 61, 63 of the U-shaped slit 60 preferably are at or slightly above the pocket or pouch 30 so that the pocket or pouch 30 prevents, inhibits, or limits tearing at the ends of the U-shaped slit. A flap 70 is formed within the U-shaped slit 60. The flap 70 has left and right vertical portions 72, 74 and a curved top portion 76. A bottom portion 78 of the flap 70 is integral with the base 20. The flap 70 can be folded around the bottom portion 78. A hanging portion 80 is formed between the U-shaped slit 60 and the left, right, and top edges 22, 24, 26 of the base 20. As noted above, the U-shaped slot 60 merely is an example of many options for forming an opening in the base 20. Holes and/or arrays of slits, such as radially aligned slits, may be used.

The hanging portion 80 is dimensioned to be mounted over a neck 110 of a bottle 100. An inner dimension of the hanging portion 80, defined by the U-shaped slit 60, should fit over a bottle cap 120 and hang loosely around the neck 110 of the bottle 100. The hanging placard 10 preferably lays flat against a body 130 of the bottle 100 with the pocket or pouch 30 facing outward and away from the body 130. The flap 70 extends outward from the hanging placard 10 and is substantially planar with the base 20. Alternatively, the flap 70 may be folded inward around the bottom portion 78 so that it is sandwiched between the base 20 and the body 130 of the bottle 100.

The item 50 is preferably a product sample, instruction or disclosure booklet, coupon or promotional material. For example, a hanging placard 10 may contain a recipe booklet retained in the pocket or pouch 30 and may be mounted on a wine bottle that is intended to be paired with the particular recipe. In a second example, a powdered drink mix is inserted into the pocket or pouch 30 of a hanging placard 10 mounted on a water bottle. In another example, a condiment or spice packet may be inserted into the pocket or pouch 30 of a hanging placard 10. For instance, a sample of dry spice rub may be included in a hanging placard 10 mounted on a bottle of barbeque sauce to entice a consumer to use the spices and barbeque sauce together.

The hanging placard 10 may also be mounted on a door knob. For instance, a tourist map and local business information may be inserted into the pocket or pouch 30 of a hanging placard 10 that is mounted on a hotel room door knob. A hotel guest would take the map or information when exiting the hotel room and would be more likely to visit local businesses. Alternatively, a local merchant or political candidate may mount hanging placards 10 on doors in a particular neighborhood with information relating to a business or upcoming election. The hanging placard 10 is particularly advantageous in these situations because the item 50 would be enclosed and therefore protected from weather damage.

The hanging placard 10 may also be mounted on a household appliance, such as a refrigerator or dishwasher with an instruction manual in the pocket or pouch 30. The instruction manual for appliances is often accidently thrown out with packaging materials. The hanging placard 10 would assure that the instruction manual is secure during installation of the appliance.

A method is provided for manufacturing the hanging placard 10. The method includes unwinding a continuous web of base material 300 and a continuous web of film 320 (step 200). The method includes placing an item 50, such as a coupon or promotional material on the web of base material 300 at predetermined intervals (step 202). The method further includes applying the film 310 over the item 50 and on the base material 300 adjacent to the bottom edge 302 of the base material 300 (step 204), for example by passing webs 300, 320 through a nip, between two rollers with the items 50 between the webs 300, 320. The film 320 then is secured to the base material 300 at selected locations, for example by thermal laminating, heat or sonic welding or by activating an adhesive 90 previously applied to the web of film 320 or the base material 300, thereby retaining the item 50 between the base material 300 and the film 310 (step 206). The areas of attachment of the film 320 to the base material 300 preferably extend continuously along the bottom edge 302 of the base material 300 and are spaced apart strips extending perpendicular to form pockets or pouches 30.

The method preferably proceeds with one or more die cutting steps that include cutting or punching holes or U-shaped slits 60 into the web of base material 300 at predetermined intervals (step 208). A steel rule or rotary die may be used to make the holes U-shaped slits 60. The U-shaped slits 60 preferably are disposed between the pocket or pouch 30 and a top edge 304 of the base material 300.

The method further includes cutting perforation lines 310 in the base material 300 at areas between the pockets or pouches 30 such that the base material 300 can be separated into individual hanging placards 10 with pockets 30 or enclosed pouches (step 210).

The method may further include adding a decorative edge to each of the individual hanging placards 10 (step 212). The decorative edge may be rounded or any type of pattern.

The method may further include cutting, overlaying or perforating the top film in-line so that the pocket or pouch 30 is easier to open (step 214).

The method may also include winding the plurality of hanging placards 10 onto a role for shipping and storage (step 216). The role of hanging placards 10 may be shipped with products and separated along the perforation lines to be mounted on products at the point of sale either manually or with an automatic bandolier inserter.

The method also includes hanging the hanging placard 10 on the bottle 100, doorknob or other object (step 218). In mounting the hanging placard 10 on a bottle, the hanging portion 80 is looped over and around the neck 110 so that the hanging placard 10 hangs over the body 130 of the bottle.

Although the disclosure herein has been described with reference to particular illustrative embodiments, it is to be understood that these embodiments are merely illustrative of the principles and applications of the present disclosure. Therefore numerous modifications may be made to the illustrative embodiments and other arrangements may be devised without departing from the spirit and scope of the present disclosure, which is defined by the appended claims.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A hanging placard assembly, comprising:
a base layer having left and right edges and top and bottom edges;
a hole or at least one slit in the base spaced in from the edges of the base, and a hanging portion being defined between the hole or slit and the top edge of the base;
a film overlying at least a portion of the base between the bottom edge and the hole or slit, the film being secured to the base in proximity to the bottom edge and the side edges and central areas of the film being unattached to the base to define a pocket or pouch; and
promotional material retained in the pocket or pouch of the hanging placard assembly between the base layer and the film.

2. The hanging placard assembly of claim 1, wherein the base layer is printed to have a graphic, copy or other indicia.

3. The hanging placard assembly of claim 2, wherein the top edge of the base is curved so that a distance between the top edge and the bottom edge is greater at a position equidistant from the left and right edges than at positions nearer the left or right edge.

4. The hanging placard assembly of claim 1, the film is cut, overlaid, or perforated so that the pocket or pouch is easily opened.

5. The hanging placard assembly of claim 1, wherein the film is affixed to the base with a heat activated adhesive.

6. The hanging placard assembly of claim 1, wherein the film is affixed to the base by thermal lamination.

7. The hanging placard assembly of claim 1, wherein the U-shaped slit is dimensioned so that a neck of a bottle or other object can be passed between the left and right sections and the curved section of the U-shaped slit.

8. A bottle assembly with information display comprising:
a bottle having a body and a neck extending from the body;
a hanging placard assembly with a base layer having left and right edges and top and bottom edges;
a hole or at least one slit in the base spaced in from the edges of the base, and a hanging portion being defined between the hole or slit and the top edge of the base;
a top film overlying at least a portion of the base between the bottom edge and the flap, the film being secured to the base in proximity to the bottom edge and the side edges and central areas of the top film being unattached to the base to define a pocket or pouch; and
promotional material retained in the pocket or pouch of the hanging placard assembly between the base layer and the film.

9. The hanging placard assembly of claim 8, wherein the base layer is printed to have a graphic, copy or other indicia.

10. The hanging placard assembly of claim 9, wherein the top edge of the base is curved so that a distance between the top edge and the bottom edge is greater at a position equidistant from the left and right edges than at positions nearer the left or right edge.

11. The hanging placard assembly of claim 8, wherein the film is cut, overlaid, or perforated so that the pocket or pouch is easily opened.

12. The hanging placard assembly of claim 8, wherein the top film is affixed to the base with an adhesive.

13. The hanging placard assembly of claim 8, wherein the top film is welded to the base.

14. A method for manufacturing a plurality of hanging placards, the method comprising the steps of:
placing a plurality of items on a continuous web of base material at predetermined intervals;
applying a top film over the plurality of items and the sheet of base material adjacent to a bottom edge of the base material;
securing the film to the base material at selected locations to form a plurality of pockets or pouches;
cutting or punching a plurality of holes or slits into the elongated base material at predetermined intervals aligned with and spaced from the plurality of pockets or pouches; and
cutting perforation lines in the top film and base material in areas between the pockets or pouches.

15. The method of claim 14, wherein the top film is secured to the base material by a heat activated adhesive.

16. The method of claim 14, wherein the top film is secured to the base material by self-wound overlaminate.

17. The method of claim 14, wherein the top film is secured to the base material by heat or sonic welding.

18. The method of claim 14, further comprising the step of cutting, overlaying, or perforating the top film so that the pocket or pouch can be opened.

19. The method of claim 14, further comprising the step of separating the plurality of hanging placards with pouches into individual hanging placards by cutting or tearing along the perforation lines.

20. The method of claim 19, further comprising the step of hanging the individual hanging placards on bottles.
